(19) United States
(12) Patent Application Publication
(10) Pub. No.: US 2026/0239029 A1
(43) Pub. Date: Aug. 13, 2026

(54) METHOD BY WHICH TERMINAL FOR SUPPORTING MULTI-SIM PERFORMS SON/MDT, AND DEVICE

(71) Applicant: Samsung Electronics Co., Ltd., Suwon-si, Gyeonggi-do (KR)

(72) Inventor: Sangbum KIM, Suwon-si (KR)

(21) Appl. No.: 19/153,469

(22) PCT Filed: Feb. 19, 2024
(86) PCT No.: PCT/KR2024/095406

§ 371 Date: Aug. 4, 2025

(30) Foreign Application Priority Data
Feb. 20, 2023 (KR) 10-2023-0022388

(51) Int. Cl. H04W 24/02; H04W 68/02; H04W 76/20; H04W 76/30

(52) U.S. Cl. CPC H04W 24/02; H04W 68/02; H04W 76/20; H04W 76/30

(57) ABSTRACT

A method of a terminal, according to one embodiment of the present disclosure, may comprise receiving a measurement configuration for logged minimization of drive test (MDT) from a first base station of a first network related to a first subscriber identity module (SIM) of the terminal; entering a radio resource control (RRC) inactive state or an RRC idle state based on an RRC release message received from the first base station; and in case that the logged MDT is affected by paging received from a second base station of a second network related to a second SIM of the terminal or by data received from the second base station or transmitted to the second base station, transmitting, to the first base station, a measurement result including an indicator indicating that the logged MDT has been affected.

### TECHNICAL FIELD

The disclosure relates to terminal and base station operations in a mobile communication system. More particularly, the disclosure relates to a method and a device for performing self-organizing network (SON)/minimization of drive test (MDT) supporting a multi-SIM in a mobile communication system.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE

### Technical Problem

Embodiments of the disclosure provide a device and a method in which a UE supporting multi-subscriber identity module (SIM) performs MDT in a mobile communication system.

### Technical Solution

According to an aspect of the disclosure to solve the problem, a method performed by a terminal in a wireless communication system includes receiving a measurement configuration for logged minimization of drive test (MDT) from a first base station of a first network related to a first subscriber identity module (SIM) of the terminal; entering a radio resource control (RRC) inactive state or an RRC idle state based on an RRC release message received from the first base station; and in case that the logged MDT is affected by paging received from a second base station of a second network related to a second SIM of the terminal or by data received from the second base station or transmitted to the second base station, transmitting, to the first base station, a measurement result including an indicator indicating that the logged MDT has been affected.

According to another aspect of the disclosure to solve the problem, a method performed by a base station of a first network related to a first subscriber identity module (SIM) of a terminal in a wireless communication system includes transmitting a measurement configuration for logged minimization of drive text (MDT) to the terminal; transmitting a radio resource control (RRC) release message for the terminal to enter an RRC inactive state or an RRC idle state; and

in case that the logged MDT is affected by paging transmitted from a second base station of a second network related to a second SIM of the terminal or by data transmitted from the second base station receiving, from the terminal, a measurement result including an indicator indicating that the logged MDT has been affected. According to another aspect of the disclosure to solve the problem, a terminal in a wireless communication system includes a transceiver; and a controller coupled with the transceiver and configured to: receive a measurement configuration for logged minimization of drive test (MDT) from a first base station of a first network related to a first subscriber identity module (SIM) of the terminal; enter a radio resource control (RRC) inactive state or an RRC idle state based on an RRC release message received from the first base station; and in case that the logged MDT is affected by paging received from a second base station of a second network related to a second SIM of the terminal or by data received from the second base station or transmitted to the second base station, transmit, to the first base station, a measurement result including an indicator indicating that the logged MDT has been affected.

According to another aspect of the disclosure to solve the problem, a base station of a first network related to a first subscriber identity module (SIM) of a terminal in a wireless communication system includes a transceiver; and a controller coupled with the transceiver and configured to: transmit a measurement configuration for logged minimization of drive text (MDT) to the terminal; transmit a radio resource control (RRC) release message for the terminal to enter an RRC inactive state or an RRC idle state; and in case that the logged MDT is affected by paging transmitted from a second base station of a second network related to a second SIM of the terminal or by data transmitted from the second base station, receive, from the terminal, a measurement result including an indicator indicating that the logged MDT has been affected.

### Advantageous Effect

Through embodiments of the disclosure, a UE supporting a multi-SIM can efficiently perform MDT in a mobile communication system.

### DESCRIPTION OF DRAWINGS

FIG. 1 is a diagram illustrating a structure of a next-generation mobile communication system according to an embodiment of the disclosure.

FIG. 2 is a diagram illustrating a radio access state transition in the next-generation mobile communication system according to an embodiment of the disclosure.

FIG. 3 is a diagram illustrating a UE supporting a plurality of subscriber identity modules (SIMs) according to an embodiment of the disclosure.

FIG. 4 is a diagram illustrating a technology of collecting and reporting cell measurement information according to an embodiment of the disclosure.

FIG. 5 is a diagram illustrating a method of collecting and reporting cell measurement information according to an embodiment of the disclosure.

FIG. 6 is a flowchart illustrating an operation of collecting and reporting cell measurement information according to an embodiment of the disclosure.

FIG. 7 is a diagram illustrating the case where measurement information cannot be collected according to logged MDT in a MUSIM environment according to an embodiment of the disclosure.

FIG. 8 is a diagram illustrating a first method of performing the logged MDT operation in the MUSIM environment according to an embodiment of the disclosure.

FIG. 9 is a diagram illustrating a second method of performing the logged MDT operation in the MUSIM environment according to an embodiment of the disclosure.

FIG. 10 is a diagram illustrating a third method of performing the logged MDT operation in the MUSIM environment according to an embodiment of the disclosure.

FIG. 11 is a flowchart illustrating a UE operation of performing the logged MDT operation in the MUSIM environment according to an embodiment of the disclosure.

FIG. 12 is a flowchart illustrating a gNB operation of performing the logged MDT operation in the MUSIM environment according to an embodiment of the disclosure.

FIG. 13 is a block diagram illustrating an internal structure of the UE according to an embodiment of the disclosure.

FIG. 14 is a block diagram illustrating a configuration of the base station according to an embodiment of the disclosure.

### MODE FOR DISCLOSURE

In the following description of the disclosure, when it is determined that detailed description for related known functions or configurations may unnecessarily obscure the subject matter of the disclosure, the detailed description will be omitted. Hereinafter, embodiments of the disclosure are described with reference to the accompanying drawings.

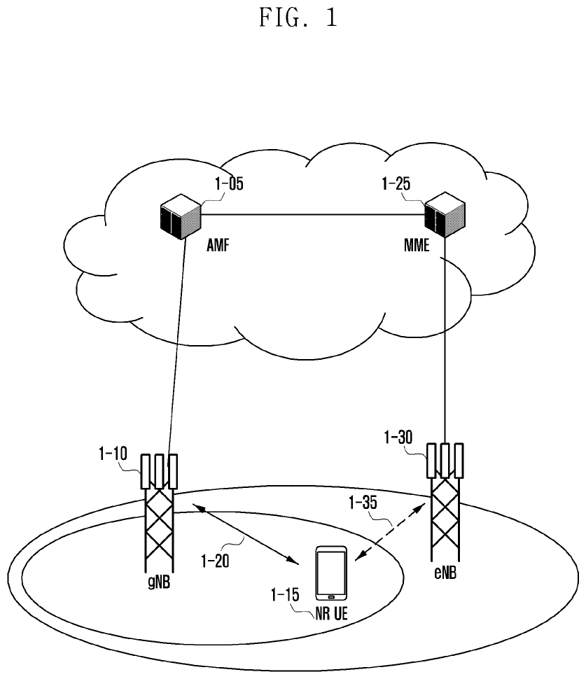

FIG. 1 is a diagram illustrating a structure of a next-generation mobile communication system.

Referring to FIG. 1, as illustrated, a radio access network of a next-generation mobile communication system (new radio (NR)) is constituted by a next-generation base station (new radio node B (gNB)) 1-10 and an AMF 1-05 (new radio core network). A user terminal (new radio user equipment, hereinafter, referred to an NR UE or a terminal) 1-15 accesses an external network through the gNB 1-10 and the AMF 1-05.

In FIG. 1, the gNB corresponds to an evolved Node B (eNB) of the conventional LTE system. The gNB may be connected to the NR UE through a radio channel and may provide a better service than the conventional node B as indicated by reference numeral 1-20. Since all user traffic is served through a shared channel in the next-generation mobile communication system, a device for gathering and scheduling status information of buffer statuses, available transmission power statuses, and channel statuses of UEs is required, which is performed by the gNB 1-10. One gNB generally controls a plurality of cells. The gNB may have a bandwidth wider than the conventional maximum bandwidth in order to implement super-high-speed data transmission compared to conventional LTE and orthogonal frequency division multiplexing (OFDM) may be additionally combined with beamforming technology through radio access technology. Further, an adaptive modulation and coding (AMC) scheme of determining a modulation scheme and a channel coding rate is applied depending on the channel status of the UE. The AMF 1-05 performs functions of supporting mobility, configuring bearers, configuring QoS, and the like. The AMF is a device that performs not only a function of managing mobility of the UE but also various control functions and is connected to a plurality of gNBs. Further, the next-generation mobile communication system may interwork with the conventional LTE system, and the AMF is connected to an MME 1-25 through a network interface. The MME is connected to an eNB 1-30, which is a conventional base station. The UE supporting LTE-NR dual connectivity may transmit and receive data while maintaining the connection not only to the gNB but also to the eNB as indicated by reference numeral 1-35.

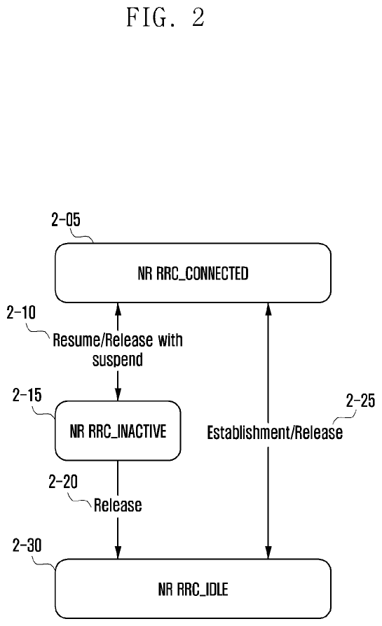

FIG. 2 is a diagram illustrating radio access state transition in the next-generation mobile communication system.

In the next-generation mobile communication system, there are three radio access states (RRC states). A connected state or connected mode (RRC_CONNECTED) 2-05 is a radio access state in which the UE can transmit and receive data. An idle state or idle mode (RRC_IDLE) 2-30 is a radio access state in which the UE monitors whether paging is transmitted to the UE itself. The two states are radio access states applied to the conventional LTE system, and detailed technology thereof is the same as that of the conventional LTE system. An inactive (RRC_INACTIVE) radio access state 2-15 is newly defined in the next-generation mobile communication system. In the RRC_INACTIVE state, UE context is maintained in the gNB and the UE and RAN-based paging is supported. Characteristics of the RRC_INACTIVE state are listed below.
Cell re-selection mobility;
CN-NR RAN connection (both C/U-planes) has been established for UE;
The UE AS context is stored in at least one gNB and the UE;
Paging is initiated by NR RAN;
RAN-based notification area is managed by NR RAN;
NR RAN knows the RAN-based notification area which the UE belongs to;

The UE in the INACTIVE state may transition to the connected state or the idle state through a specific procedure. That is, the UE may transition from the INACTIVE state to the connected state according to a resume procedure. Further, the UE may transition from the connected state to the INACTIVE state through a release procedure including suspend configuration information as indicated by reference numeral 2-10. During the procedure, one or more RRC messages are transmitted and received between the UE and the gNB, and the procedure is constituted by one or more steps. After the resume procedure, the UE can transition from the INACTIVE state to the idle state through a release procedure as indicated by reference numeral 2-20. Transitioning between the connected state and the idle state follows the conventional LTE technology. That is, through the establishment or release procedure, transitioning between the states is performed as indicated by reference numeral 2-25.

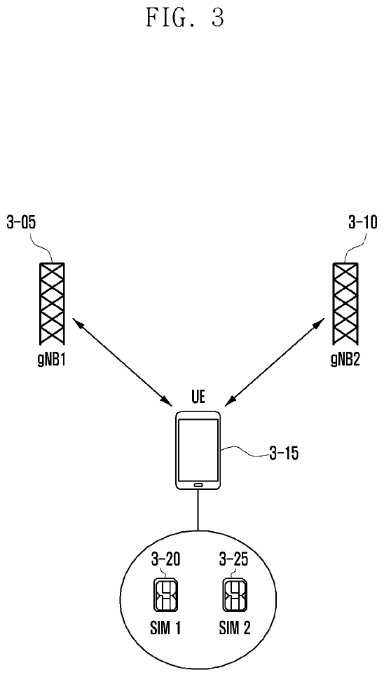

FIG. 3 is a diagram illustrating a UE supporting a plurality of subscriber identity modules (SIMs) according to an embodiment of the disclosure.

A SIM is a device that stores information on a mobile communication subscriber, and the UE is registered in and accesses the network provided by an operator to which the subscriber subscribes by using the information stored in the device. A multi-SIM UE 3-15 according to an embodiment of the disclosure is a UE supporting two or more SIMs 3-20 and 3-25. The multi-SIM UE may operate in a first state or a first mode (hereinafter, referred to as a dual SIM dual standby (DSDS) state or a DSDS mode) or a second state (hereinafter, referred to as a dual SIM dual active (DSDA) state or a DSDA mode). The DSDS state and the DSDA state may be defined as follows.
DSDS: both SIMs can be used for idle-mode network connection, but when a radio connection (3-05) is active the second connection (3-10) is disabled. As in the passive case, the SIMs in a DSDS device share a single transceiver. Through time multiplexing two radio connections are maintained in idle mode. When in-call on network for one SIM it is no longer possible to maintain radio connection to the network of the second SIM, hence that connection is unavailable for the duration of the call. Registration to the second network is maintained
DSDA: both SIMs can be used in both idle and connected modes. Each SIM has a dedicated transceiver, meaning that there are no interdependencies on idle or connected mode operation at the modem level

When the UE supporting a plurality of SIMs has one RF chain (or transceiver), the UE may transmit and receive data in a connected state to a first network corresponding to a first SIM, and collision may occur when the UE receives paging from a second network corresponding to a second SIM. Accordingly, in this case, the UE may have difficulty in monitoring paging transmitted from the second network corresponding to the second SIM or performing an idle state operation (for example, reception of system information or public warning system (PWS) information, tracking area update (TAU), and the like).

The TAU procedure is a process of registering again a paging area periodically or when the UE reselects another cell having a different TA and needs the connection with the network. At this time, the UE requires transmission and repletion of signals to and from the network. Accordingly, the TAU operation may not be performed according to whether the UE transmits or receives a signal to or from another network (corresponding to another SIM). The RF chain is the term commonly used in communication fields and means a set of a series of RF modules (antenna, amplifier, converter/decoder, filter, and the like) that are required for data transmission and reception.

In the Rel-17 NR standard, several options have been introduced to solve the problem. For example, when paging occasions monitored from the network corresponding to the first SIM and the network corresponding to the second SIM collide with each other, the UE may request the network to change a paging monitoring pattern. Further, the UE may request a gap in which a transmission and reception operation for monitoring paging of the network corresponding to the other SIM (second SIM) is suspended to the connected network (network corresponding to the first SIM) and request a disconnection to the connected network (network corresponding to the first SIM) in order to be connected to the network corresponding to the second SIM.

When the UE support two RF chains, the UE may simultaneously receive a service from two networks corresponding to different SIMs without the mentioned problem. However, when the UE supporting the two RF chains use all of the two RF chains since CA/DC technique is configured in the network corresponding to one SIM, a method capable of smoothly performing an idle state or connected state operation in the other network is still needed. The idle state operation means paging monitoring and reception, system information reception, public warning system (PWS) information reception, tracking area update (TAU), and the like. The connected state operation means performance of a data transmission and reception operation between the UE and the gNB.

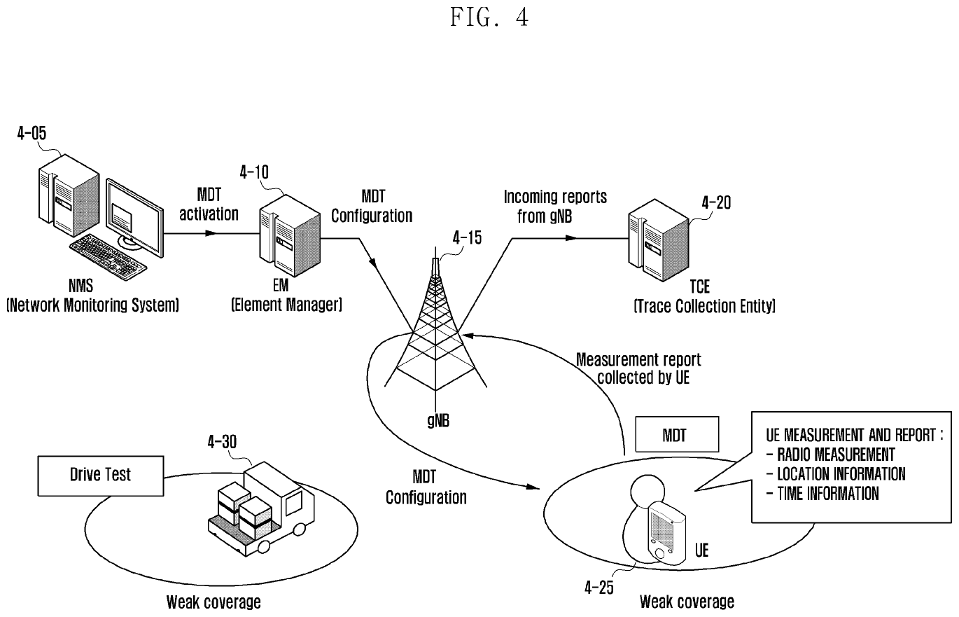

FIG. 4 is a diagram illustrating a technology for collecting and reporting cell measurement information in the disclosure.

When a network is constructed or optimized, a mobile communication operator performs a process of measuring a signal strength in a generally expected service area and placing or rearranging gNBs within the service area, based thereon. The operator loads signal measurement equipment in a vehicle and collects cell measurement information in the service area, which requires a lot of time and money. The processor generally uses a vehicle and is called a drive test. The UE has a function capable of measuring a signal in order to support operations of reselecting a cell, performing handover, adding a serving cell, or the like during movement between cells. Accordingly, instead of the drive test, a UE within the service area may be used, which is called a minimization of drive test (MDT). The operator may configure an MDT operation in specific UEs through various configuration devices of the network, and the UEs measure the signal strength from the serving cell and neighboring cells in the connected state (RRC_Connected), the idle state (RRC_Idle), or the inactive state (RRC_Inactive) and store the signal strength. In addition, the UE may also store various pieces of information such as location information, time information, and signal quality information. The stored information may be reported to the network when the UEs are in the connected state, and the information is transferred to a specific server.

The MDT operation is largely classified into an immediate MDT and a logged MDT.

The immediate MDT is characterized by reporting information measured by the UE directly to the network. Since the information measured by the UE is directly reported, the connected state UE may perform the immediate MDT. Generally, a RRM measurement process for supporting the operation of performing handover, adding the serving cell, and the like is used, and the location information, the time information, and the like are additionally reported.

The logged MDT is characterized by storing the information measured by the UE without directly reporting the same to the network, and reporting the stored information after the UE transitions to the connected state. In general, the UE in the idle state which cannot directly report the measured information to the network performs the logged MDT. The UE in the inactive state introduced in the next-generation mobile communication system performs the logged MDT. When a specific UE is in the connected state, the network provides the UE with configuration information for performing the logged MDT operation, and the UE transitions to the idle state or the inactive state and then measures and stores the configured information.

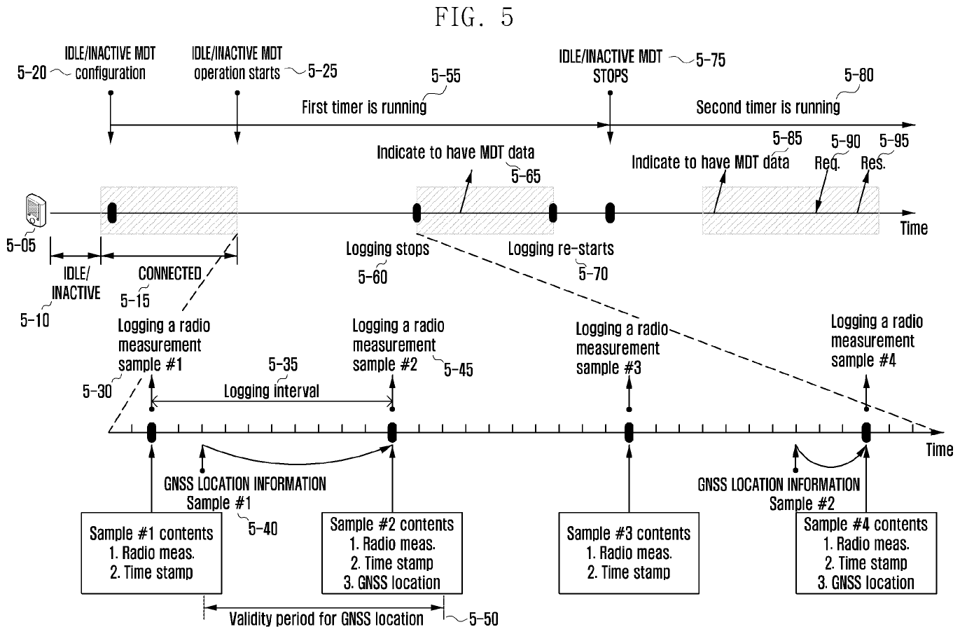

FIG. 5 is a diagram illustrating a method of
collecting and reporting cell measurement

| | RRC state |
|---|---|
| Immediate MDT | RRC_Connected |
| Logged MDT | RRC_Idle, RRC_Inactive |

information in the disclosure.

A UE 5-05 transitions form an idle state or inactive state 5-10 to a connected state 5-15. In the connected state, the UE collects MDT data through an immediate MDT operation and reports the MDT data to the gNB. Meanwhile, the immediate MDT operation may be selectively performed according to a configuration of the UE. Further, in the disclosure, information measured or collected through the MDT operation and stored by the UE is called MDT data. However, the MDT data may be used in various terms such as MDT information and logged information.

The UE transitioning to the connected state receives logged MDT configuration information performed in the idle state or the inactive state from the gNB in step 5-20. The configuration information is stored in a predetermined RRC message and transmitted to the UE, and the UE receiving the message runs a first timer in step 5-55. The UE performs the logged MDT operation in an idle state or inactive state section until the first timer expires.

A value of the first timer is included in the logged MDT configuration information. When the UE transitions to the idle state or the inactive state, the logged MDT is performed according to the logged MDT configuration information in step 5-25.

The UE may store the measured or collected information according to a configured period or a logged interval 5-35 in steps 5-30 and 5-45. Further, when valid location information 5-40 is collected, the UE may also store the location information. It is determined that the location information is valid when a predetermined time 5-50 does not pass after the information is collected. The predetermined time is shorter than or equal to the logged interval. Even before the first timer expires, the UE may stops the logged MDT operation that is performed when the UE transitions to the connected state in step 5-60. However, the first timer continuously runs without stopping in the connected state section. That is, the first timer continuously runs regardless of a change in the RRC state. However, when the UE memory storing MDT data is insufficient and cannot store any more, or when the logged MDT configuration information is released, the first timer is stopped. The case where the logged MDT configuration information is released corresponds to the case where a serving RAT or another RAT provides other logged MDT configuration information, the UE detaches from the network, or power of the UE is disconnected. The UE reports information indicating that the UE stores measured information or collected information (MDT data) to the gNB by using a RRC setup complete message or a RRC resume complete message during a connection establishment process (RRC connection establishment) or a connection resumption process (RRC connection resume).

The connection establishment process is a process in which the UE transitions from the idle state to the connected state. The connection establishment process is generally constituted by the following three steps, in which three types of RRC messages are used.
First step: the UE transmits a RRC setup request message to the gNB
Second step: the gNB transmits a RRC setup message to the UE
Third step: the UE transmits a RRC setup complete message to the gNB

The connection resumption process is a process in which the UE transitions from the inactive state to the connected state. The connection resumption process is generally constituted by three steps, in which three types of RRC messages are used.
First step: the UE transmits a RRC resume request message to the gNB
Second step: the gNB transmits a RRC resume message to the UE
Third step: the UE transmits a RRC resume complete message to the gNB

The UE may report information indicating the UE has the MDT data to a target gNB during a connection reestablishment process (RRC connection reestablishment) and a handover process in addition to the connection establishment process or the connection resumption process. When the logged MDT is configured but there is no stored information yet, the UE may omit the report.

The gNB receiving the report may request a report of the MDT data that the UE stores. For a predetermined time, the UE should continuously store MDT data that has not been reported. When the UE transitions to the idle state or the inactive state again and the first timer does not expire yet, the UE restart the logged MDT operation in step 5-70.

When the first timer expires, the logged MDT operation is stopped in step 5-75. The UE stopping the operation runs a second timer in step 5-80 and maintains the stored MDT data before the timer expires. After the time expires, whether to delete the stored MDT data is determined according to UE implementation. A value of the second timer may be included in the logged MDT configuration information, or a predefined value may be applied without the configuration.

When the UE transitions to the connected state again, the UE reports that the UE has the stored information (MDT data) to the gNB in step 5-85. At this time, the gNB requests a report of the MDT data that the UE stores by using a predetermined RRC message in step 5-90. The UE stores the MDT data stored in the predetermined RRC message and report the message to the gNB in step 5-95.

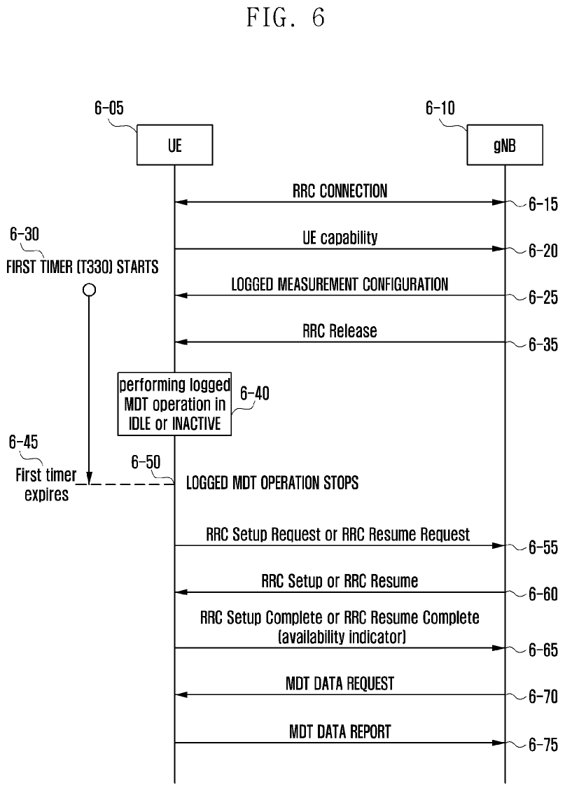

FIG. 6 is a flowchart illustrating an operation of collecting and reporting cell measurement information in the disclosure.

A UE 6-05 establishes a connection with a gNB 6-10 in step 6-15. The UE may provide UE capability information to the gNB in step 6-20 and indicate whether the UE supports the MDT operation and which frequency can be measured through the UE capability information. Meanwhile, it is not necessary to perform the step in which the UE provides the UE capability information after the UE establishes the RRC connection with the gNB. The gNB may use UE capability information previously received from the UE and stored. Alternatively, the UE may transmit the UE capability information to the gNB according to a request from the gNB and may provide the UE capability information according to a request from the gNB in steps other than step 6-20.

The gNB may store configuration information required for performing the logged MDT operation in a RRC message and transmit the RRC message to the UE in step 6-25. For example, the configuration information includes at least one piece of the following information.
Trace Reference information
Trace Recording Session Reference information
Trace collection entity (TCE) ID information: the gNB transmits MDT data information reported from the UE to a data server designated by the TCE ID.
Absolute time information: absolute time in the current cell that provides logged MDT configuration information
Area Configuration: is area information for collecting and storing measurement information through the logged MDT operation and is indicated in units of cells. Further, RAT information for collecting measurement information may be included.

A list included in the RAT information may be a black list or a white list. When the list included in the RAT information is a black list, the UE collects cell measurement information for the RAT which is not included in the list. When the list included in the RAT information is a white list, the UE does not collect cell measurement information for the RAT which is not included in the list. The area configuration may also include interFreqTargetList information. The interFreqTargetList information is a list of InterFreqTargetInfo, and InterFreqTargetInfo IE is used to indicate an adjacent frequency and cell information for which the UE should store cell measurement information, that is, ARFCN-ValueNR and a PCI (PhysicalCellId) of the cell.
Logging Duration: is a value of the first timer, and the UE performs the logged MDT operation in the idle state or the inactive state when the timer is running.
Logging Interval: is a period during which collected information is stored.
plmn-Identity List (i.e. MDT PLMN list): is PLMN list information. Not only the performance of the logged MDT operation, but also whether MDT data is stored and PLMN information for reporting the MDT data are included.
An indicator indicating whether the logged MDT operation is performed in the idle state, the inactive state, or both the idle state and the inactive state. Through the indicator, an RRC state for performing the logged MDT operation may be indicated. The UE performs the logged MDT operation only in the RRC state indicated by the indicator. Alternatively, without the indicator, it may be defined that the UE always performs the logged MDT operation in the idle state and the inactive state.
An indicator indicating whether beam level measurement information is collected and stored. In the next-generation mobile communication system, a beam antenna may be applied. Accordingly, the UE may store beam level measurement information, based on the indicator. Alternatively, without the indicator, it may be defined that the UE always collects and stores beam level measurement information for a frequency in which a beam-based operation is performed.
Information on the maximum number of collected or stored beams and information on the minimum signal strength of stored beams. The UE omits storage of information on a beam weaker than the minimum signal strength. When all beams are weaker than the configured minimum signal value, the UE may store one piece of beam information having the strongest signal strength among them or insert an indicator indicating that all beams are weaker than the configured minimum signal value.

The UE receiving the logged MDT configuration information starts the first timer (for example, T330) in step 6-30. A value of the first timer is configured to be the same as the value of the logging duration.

The gNB transitions the UE to the idle state or the inactive state by using an RRC release message in step 6-35. According to the RRC state to which the UE transitions, the RRC release message stores configuration information for the operation in the RRC state.

When the first timer is running, the UE performs the logged MDT in the idle state or the inactive state in step 6-40. The UE measures the signal strength of the serving cell and neighboring cells and acquires location information. When beam level measurement is configured, the UE collects and stores a signal strength value for a beam larger than the configured minimum value in the serving cell and the adjacent cells. The maximum number of beams which the UE can store may be configured or may be predefined. The signal strength is RSRP, RSRQ, or SINR. The UE stores the collected information according to every logged interval period.

When the first timer expires in step 6-45, the UE stops the logged MDT operation in step 6-50.

When the UE is in the idle state or the inactive state by the RRC release message and receives RAN or CN paging from the gNB or MO data transmission is activated, the UE performs an establishment process or a resume process for transitioning from the idle state or the inactive state to the connected state.

The establishment process or the resume process may be constituted by the following steps.
First step: the UE transmits an RRC setup request message or an RRC resume request message to the gNB in step 6-55.
Second step: the gNB transmits an RRC setup message or an RRC resume message to the UE in step 6-60.
Third step: the UE transmits an RRC setup complete message or an RRC resume complete message to the gNB in step 6-65.

The UE stores an indicator (availability indicator) indicating whether the UE stores MDT data in the RRC setup complete message or the RRC resume complete message. The gNB receiving the RRC setup complete message requests a report of the MDT data by using a predetermined RRC message of UEInformationRequest as necessary in step 6-70. The UE receiving the request reports the MDT data by using a predetermined RRC message of UEInformationResponse in step 6-75.

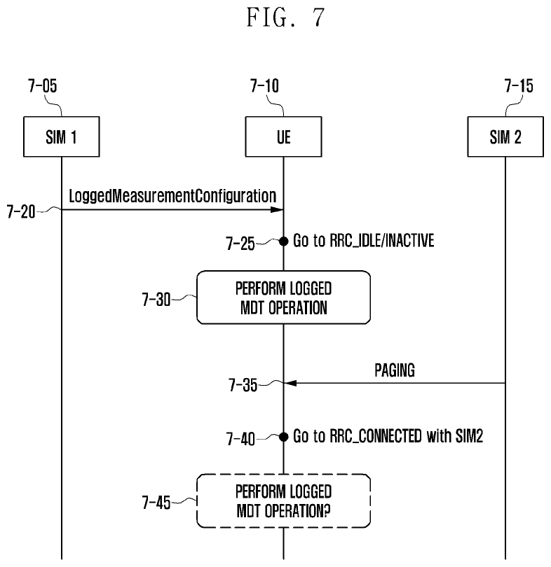

FIG. 7 is a diagram illustrating the case where measurement information cannot be collected according to logged MDT configured in a multi-SIM (MUSIM) environment according to an embodiment of the disclosure.

A UE 7-10 is registered in networks 7-05 and 7-15 corresponding to two SIMs. In the disclosure, the network corresponding to the SIM may be expressed as a SIM network.

The UE receives a LoggedMeasurementConfiguration message including logged MDT configuration information from the first SIM network in the state where the UE is connected to the first SIM network 7-05 in step 7-20.

After transitioning to the idle state (RRC_IDLE) or the inactive state (RRC_INACTIVE) in step 7-25, the UE may perform the logged MDT operation, that is, an operation of collecting and storing cell measurement information according to the configuration information in step 7-30.

Thereafter, the UE may receive paging from the second SIM network 7-15 in step 7-35 and may be connected to the network in step 7-40. The UE may perform a data transmission and reception operation according to scheduling of the second network and measure a cell or a frequency according to a cell measurement configuration of the network. This can mean that there may be a limitation in collecting the cell measurement information according to the logged MDT configuration information received from the first SIM network by the UE in step 7-45. For example, in order to measurement a cell of a specific frequency, an RF chain should be adjusted to receive a reference signal of the corresponding cell, but the RF chain may be used to transmit and receive a signal from the serving cell configured by the second SIM network.

Since the UE communicates with a network different from the network from which the logged MDT configuration information is received in a MUSIM environment, when the cell measurement information according to the received logged MDT configuration information cannot be collected, the embodiment proposes a method of controlling the case. In the disclosure, one of first, second, and third methods described below may be applied or two or more of the first to third methods may be applied at the same time.

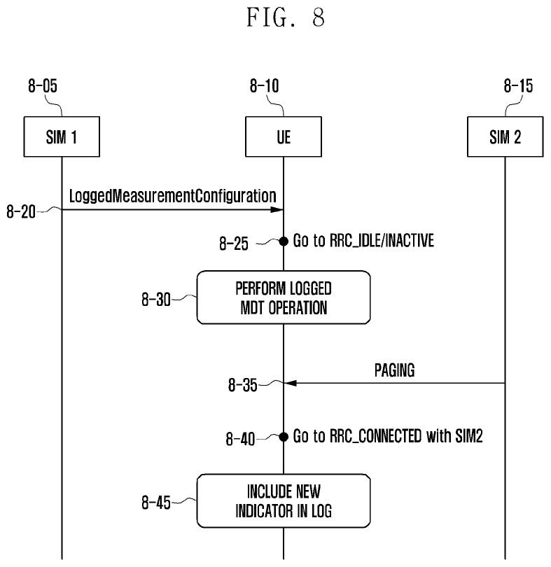

FIG. 8 is a diagram illustrating a first method of performing the logged MDT operation in the MUSIM environment according to an embodiment of the disclosure.

The first method is characterized in that, when collecting cell measurement information according to logged MDT configuration information is affected since the UE communicates with a SIM network different from the network from which the logged MDT configuration information is received due to MUSIM supporting, the UE stores a predetermined indicator indicating the same and reports the same to the gNB.

A UE 8-10 is registered in two SIM networks 8-05 and 8-15.

The UE receives a LoggedMeasurementConfiguration message including logged MDT configuration information from the network in the state where the UE is connected to the first SIM network 8-05 in step 8-20.

After transitioning to the idle state (RRC_IDLE) or the inactive state (RRC_INACTIVE) in step 8-25, the UE may perform the logged MDT operation, that is, an operation of collecting and storing cell measurement information according to the configuration information in step 8-30.

Thereafter, the UE may receive paging from the second SIM network 8-15 in step 8-35 and may be connected to the network in step 8-40. The UE may perform a data transmission and reception operation according to scheduling of the second network and measure a cell or a frequency according to a cell measurement configuration of the network. Accordingly, when there is a limitation in collecting the cell measurement information according to the logged MDT configuration information received from the first SIM network by the UE, a predetermined indicator indicating that the UE was affected is included into log(s) corresponding to the affected time interval (that is, LogMeasInfo IE(s), logged information, or MDT information) in step 8-45. Although there is the limitation in collecting the cell measurement information according to the logged MDT configuration information due to the MUSIM supporting, the UE still performs the MDT operation for the cell or frequency that can be collected according to the preset logged MDT configuration information and runs the T330 timer as it is.

When the indicator is reported to the gNB, the indicator is included in the log (that is, LogMeasInfo IE) affected by collecting of the cell measurement information. For communication with the second SIM network, the UE may not collect adjacent cell measurement information according to the preset logged MDT configuration information during a specific time interval. The UE may not include measResultServingCell in a LogMeasInfo IE corresponding to the specific time interval, not include any information in a measResultNeighCells field, or may not include an NR/ETURA cell that is not measured in a measResultNeighCellListNR or measResultNeighCellListEUTRA field. In another method, the UE includes the measResultServingCell field in the LogMeasInfo IE, but may include a measurement result of the last collected valid serving cell (on which the UE camps) in the measResultServingCell field. Further, the UE may configure a servCellIdentity field as global cell identity of the last collected valid serving cell.

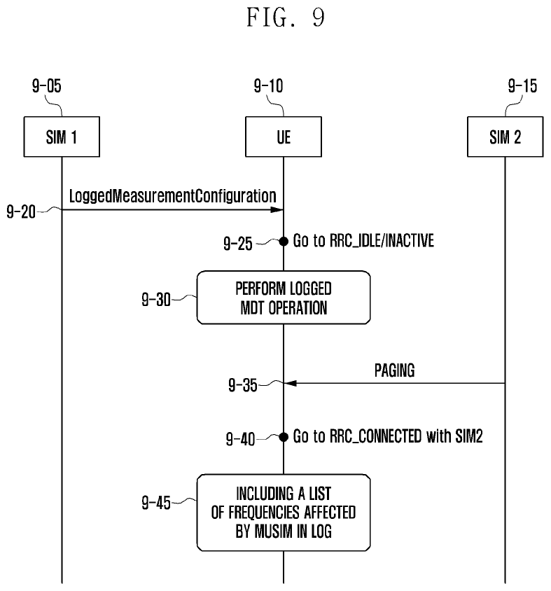

FIG. 9 is a diagram illustrating a second method of performing the logged MDT operation in the MUSIM environment according to an embodiment of the disclosure.

The second method is characterized in that, since the UE communicates with a SIM network different from the network from which the logged MDT configuration information is received due to MUSIM supporting, information on at least one of a cell or a frequency affected by collecting of the cell measurement information according to the logged MDT configuration information is stored and reported to the gNB.

A UE 9-10 is registered in two SIM networks 9-05 and 9-15.

The UE receives a LoggedMeasurementConfiguration message including logged MDT configuration information from the network in the state where the UE is connected to the first SIM network 9-05 in step 9-20.

After transitioning to the idle state (RRC_IDLE) or the inactive state (RRC_INACTIVE) in step 9-25, the UE may perform the logged MDT operation, that is, an operation of collecting and storing cell measurement information according to the configuration information in step 9-30.

Thereafter, the UE may receive paging from the second SIM network 9-15 in step 9-35 and may be connected to the network in step 9-40. The UE may perform a data transmission and reception operation according to scheduling of the second network and measure a cell or a frequency according to a cell measurement configuration of the network. Accordingly, when there is a limitation in collecting the cell measurement information according to the logged MDT configuration information received from the first SIM network by the UE, information on at least one of the affected cell or frequency is included in log(s) corresponding to the affected time interval (that is, LogMeasInfo IE(s), logged information, or MDT information) in step 9-45 Although there is the limitation in collecting the cell measurement information according to the logged MDT configuration information due to the MUSIM supporting, the UE still performs the MDT operation for the cell or frequency that can be collected according to the preset logged MDT configuration information and runs the T330 timer as it is.

When the information on at least one of the affected cell or frequency is reported to the gNB, the information is included in the corresponding log (that is, LogMeasInfo IE). For communication with the second SIM network, the UE may not collect serving or adjacent cell measurement information according to the preset logged MDT configuration information during a specific time interval, and may store cell (PCI or CGI) or frequency information (ARFCN-ValueNR) corresponding thereto and report the same in a list form to the gNB. At this time, the specific cell or frequency may be still collected according to the preset logged MDT configuration information. The cell or frequency that can be collected may be reported to the gNB through the existing IE or field within the LogMeasInfo IE.

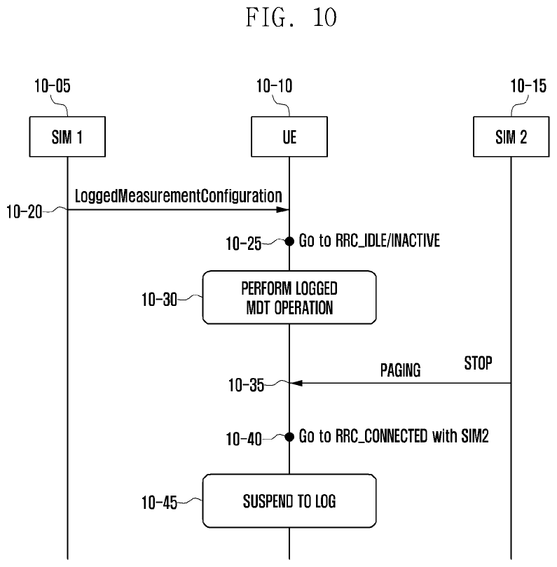

FIG. 10 is a diagram illustrating a third method of performing the logged MDT operation in the MUSIM environment according to an embodiment of the disclosure.

The third method is characterized in that, when collecting cell measurement information according to logged MDT configuration information is affected since the UE communicates with a SIM network different from the network from which the logged MDT configuration information is received due to MUSIM supporting, the UE suspends the logged MDT operation.

A UE 10-10 is registered in two SIM networks 10-05 and 10-15.

The UE receives a LoggedMeasurementConfiguration message including logged MDT configuration information from the network in the state where the UE is connected to the first SIM network 10-05 in step 10-20.

After transitioning to the idle state (RRC_IDLE) or the inactive state (RRC_INACTIVE) in step 10-25, the UE may perform the logged MDT operation, that is, an operation of collecting and storing cell measurement information according to the configuration information in step 10-30.

Thereafter, the UE may receive paging from the second SIM network 10-15 in step 10-35 and may be connected to the network in step 10-40. The UE may perform a data transmission and reception operation according to scheduling of the second network and measure a cell or a frequency according to a cell measurement configuration of the network. Accordingly, when there is a limitation in collecting the cell measurement information according to the logged MDT configuration information received from the first SIM network by the UE, the UE suspends the logged MDT operation in step 10-45. Although the logged MDT operation is suspended, the T330 timer is still run.

When an InterFreqTargetInfo IE is configured and at least one of the frequencies included in the IE is affected by the MUSIM in the recent logging interval or when the InterFreqTargetInfo IE is not configured and is affected by the MUSIM, the UE determines whether logged MDT measurement information is stored in VarLogMeasReport which is a UE parameter. When the logged MDT measurement information is stored, the UE includes an indicator indicating the influence of the MUSIM in a log (that is, LogMeasInfo IE(s), logged information, or MDT information) and suspends the logged MDT operation (measurement logging) from the next logging interval. When the logged MDT measurement information is not stored, the UE immediately suspends the logged MDT operation.

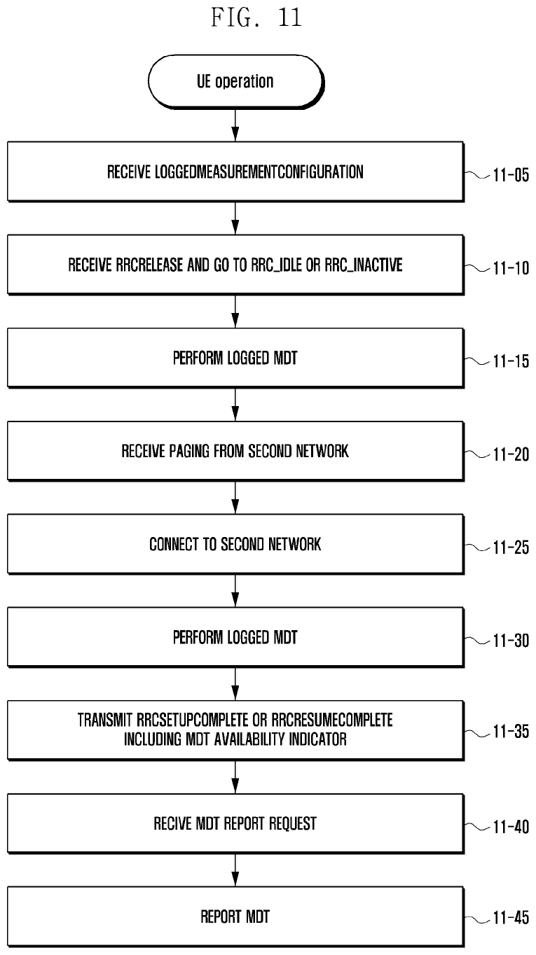

FIG. 11 is a flowchart illustrating a UE operation of performing the preset logged MDT operation in the MUSIM environment according to an embodiment of the disclosure.

In step 11-05, the UE receives a LoggedMeasurementConfiguration message from a gNB of a first network.

In step 11-10, the UE receives an RRCRelease message from the gNB and transitions to an idle state or an inactive state.

In step 11-15, the UE performs a logged MDT operation according to configuration information received in the LoggedMeasurementConfiguration message.

In step 11-20, the UE receives paging from the gNB of a second network.

In step 11-25, the UE is connected to the second network.

In step 11-30, the UE performs the logged MDT operation according to the embodiment.

In step 11-35, the UE transitions to a connected state in the first network through an RRC (re) establishment or RRC resume process. The UE reports an indicator indicating that there is a stored MDT measurement result to the gNB of the first network during the process.

In step 11-40, the UE receives a request for reporting the MDT measurement result from the gNB of the first network.

In step 11-45, the UE reports the stored MDT measurement result to the gNB of the first network.

At this time, when the MDT operation is affected by the communication of the UE with the second network, at least one piece of information configured according to a method proposed in the first method to the third method may be included in the MDT measurement result reported by the UE. A detailed description is the same as the above description and is omitted hereinafter.

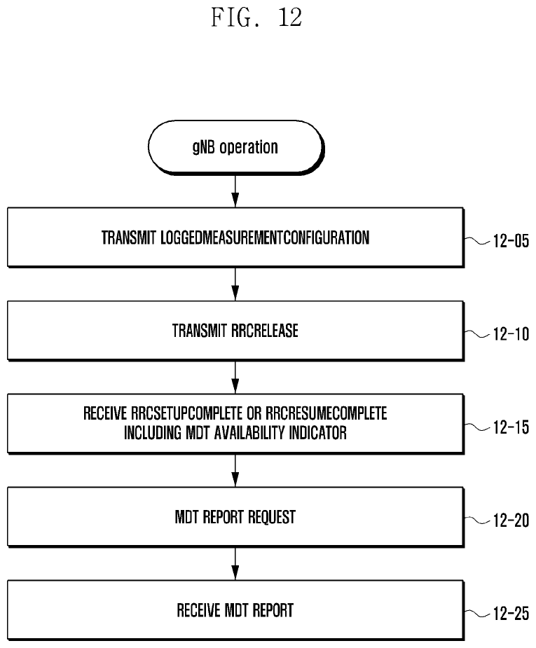

FIG. 12 is a flowchart illustrating a gNB operation of performing the preset logged MDT operation in the MUSIM environment according to an embodiment of the disclosure.

In step 12-05, the gNB transmits a LoggedMeasurementConfiguration message to the UE.

In step 12-10, the gNB transmits an RRCRelease message to the UE in order to transition the UE to an idle state or an inactive state.

In step 12-15, the gNB receives an indicator indicating that there is an MDT measurement result which the UE stores through a logged MDT process from the UE through an RRC (re) establishment or RRC resume process.

In step 12-20, the gNB requests a report of the MDT measurement result to the UE.

In step 12-25, the gNB receives a report on the requested MDT measurement result from the UE. At this time, when the MDT operation is affected by the communication of the UE with the second network, at least one piece of information configured according to a method proposed in the first method to the third method may be included in the MDT measurement result reported by the UE. A detailed description is the same as the above description and is omitted hereinafter.

Accordingly, through the information included in the MDT measurement result, the gNB may distinguish the result affected by the MUSIM.

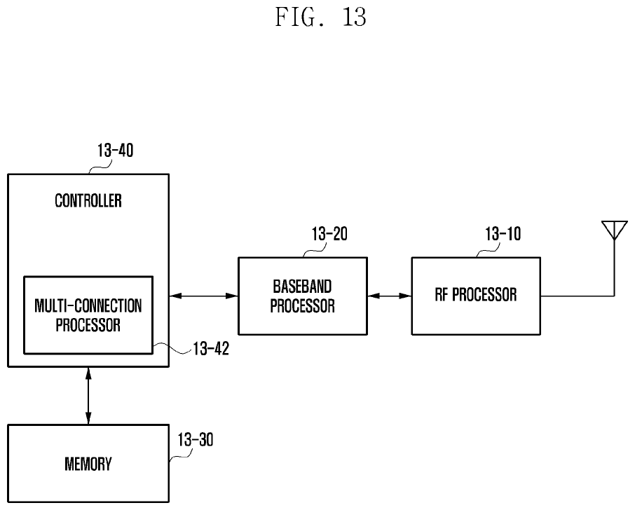

FIG. 13 is a block diagram illustrating an internal structure of the UE to which the disclosure is applied.

Referring to FIG. 13, the UE includes a radio-frequency (RF) processor 13-10, a baseband processor 13-20, a memory 13-30, and a controller 13-40.

The RF processor 13-10 performs a function of transmitting and receiving a signal through a radio channel such as converting a band of the signal or amplifying the signal. That is, the RF processor 13-10 up-converts a baseband signal provided from the baseband processor 13-20 into an RF band signal, transmits the RF band signal through an antenna, and then down-converts the RF band signal received through the antenna into a baseband signal. For example, the RF processor 13-10 may include a transmission filter, a reception filter, an amplifier, a mixer, an oscillator, a digital-to-analog converter (DAC), an analog-to-digital converter (ADC), and the like. Although FIG. 13 illustrates only one antenna, the UE may have a plurality of antennas. The RF processor 13-10 may include a plurality of RF chains. Moreover, the RF processor 13-10 may perform beamforming. For the beamforming, the RF processor 13-10 may control a phase and a size of each of the signals transmitted and received through a plurality of antennas or antenna elements. The RF processor may perform MIMO and may receive a plurality of layers during the MIMO operation.

The baseband processor 13-20 performs a function for conversion between a baseband signal and a bitstream according to a physical layer standard of the system. For example, in data transmission, the baseband processor 13-20 generates complex symbols by encoding and modulating a transmission bitstream. Further, in data reception, the baseband processor 13-20 restores a reception bitstream by demodulating and decoding a baseband signal provided from the RF processor 13-10. For example, in an orthogonal frequency division multiplexing (OFDM) scheme, when data is transmitted, the baseband processor 13-20 generates complex symbols by encoding and modulating a transmission bitstream, mapping the complex symbols to subcarriers, and then configures OFDM symbols through an inverse fast Fourier transform (IFFT) operation and a cyclic prefix (CP) insertion. Further, when data is received, the baseband processor 13-20 divides the baseband signal provided from the RF processor 13-10 in the unit of OFDM symbols, restores the signals mapped to the subcarriers through a fast Fourier transform (FFT) operation, and then restores a reception bitstream through demodulation and decoding.

The baseband processor 13-20 and the RF processor 13-10 transmits and receives a signal as described above. Accordingly, the baseband processor 13-20 and the RF processor 13-10 may be referred to as a transmitter, receiver, a transceiver, or a communication unit. At least one of the baseband processor 13-20 and the RF processor 13-10 may include a plurality of communication modules for supporting a plurality of different radio access technologies. Further, at least one of the baseband processor 13-20 and the RF processor 13-10 may include different communication modules to processing signals in different frequency bands. For example, the different radio access technologies may include a wireless LAN (for example, IEEE 802.11) and a cellular network (for example, LTE). Further, the different frequency bands may include a super high frequency (SHF) (for example, 2.NRHz, NRhz) band and a millimeter (mm) wave (for example, 60 GHz) band.

The memory 13-30 stores basic programs, application programs, and data such as configuration information for the operation of the UE. Particularly, the memory 13-30 may store information related to a second access node that performs wireless communication using a second radio access technology. The memory 13-30 provides stored data according to a request from the controller 13-40.

The controller 13-40 controls the overall operations of the UE. For example, the controller 13-40 transmits and receives a signal through the baseband processor 13-20 and the RF processor 13-10. The controller 13-40 records data in the memory 13-30 and reads the data. To this end, the controller 13-40 may include at least one processor. For example, the controller 13-40 may include a communications processor (CP) that performs control for communication, and an application processor (AP) that controls higher layers such as an application program.

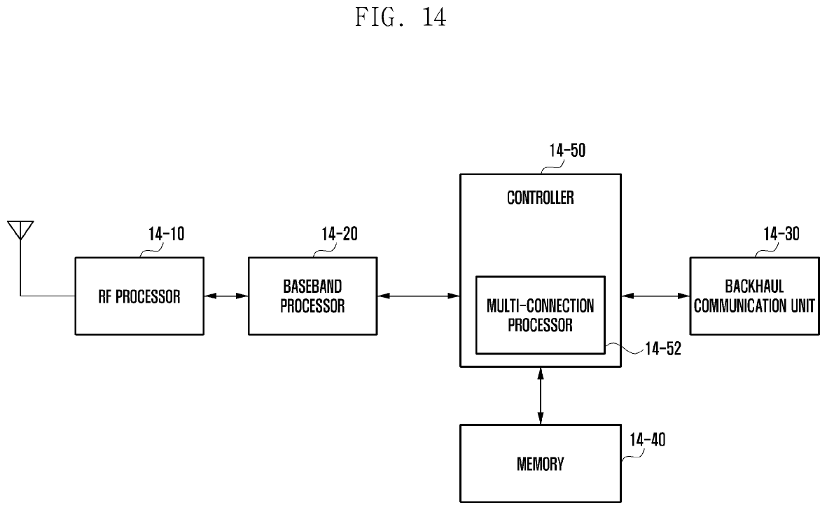

FIG. 14 is a block diagram illustrating a configuration of a base station according to the disclosure.

As illustrated in FIG. 14, the base station includes an RF processor 14-10, a baseband processor 14-20, a backhaul communication unit 14-30, a memory 14-40, and a controller 14-50.

The RF processor 14-10 performs a function of transmitting and receiving a signal through a radio channel such as converting a band of the signal or amplifying the signal. That is, the RF processor 14-10 up-converts a baseband signal provided from the baseband processor 14-20 into an RF band signal and then transmits the converted signal through an antenna, and down-converts an RF band signal received through the antenna into a baseband signal. For example, the RF processor 14-10 may include a transmission filter, a reception filter, an amplifier, a mixer, an oscillator, a DAC, an ADC and the like. Although FIG. 14 illustrates only one antenna, the first access node may include a plurality of antennas. The RF processor 14-10 may include a plurality of RF chains. The RF processor 14-10 may perform beamforming. For the beamforming, the RF processor 14-10 may control a phase and a size of each of the signals transmitted and received through a plurality of antennas or antenna elements. The RF processor may perform a downlink MIMO operation by transmitting one or more layers.

The baseband processor 14-20 performs a function of performing conversion between a baseband signal and a bitstream according to a physical layer standard of the first radio access technology. For example, in data transmission, the baseband processor 14-20 generates complex symbols by encoding and modulating a transmission bitstream. Further, in data reception, the baseband processor 14-20 restores a reception bitstream by demodulating and decoding a baseband signal provided from the RF processor 14-10. For example, in an OFDM scheme, when data is transmitted, the baseband processor 14-20 may generate complex symbols by encoding and modulating the transmission bitstream, map the complex symbols to subcarriers, and then configure OFDM symbols through an IFFT operation and CP insertion. In addition, in data reception, the baseband processor 14-20 divides a baseband signal provided from the RF processor 14-10 in units of OFDM symbols, restores signals mapped with subcarriers through an FFT operation, and then restores a reception bitstream through demodulation and decoding. The baseband processor 14-20 and the RF processor 14-10 transmits and receives a signal as described above. Accordingly, the baseband processor 14-20 and the RF processor 14-10 may be referred to as a transmitter, a receiver, a transceiver, a communication unit, or a wireless communication unit.

The backhaul communication unit 14-30 provides an interface for communicating with other nodes within the network. That is, the backhaul communication unit 14-30 converts a bitstream transmitted from the main base station to another node, for example, a secondary base station or a core network, into a physical signal and converts a physical signal received from the other node into the bitstream.

The memory 14-40 stores basic programs, application programs, and data such as configuration information for the operation of the main base station. Particularly, the memory 14-40 may store information on bearers allocated to the accessed UE, the measurement result reported from the accessed UE, and the like. The memory 14-40 may store information that is a reference for determining whether to provide multiple connections to the UE or stop the same. The memory 14-40 provides stored data according to a request from the controller 14-50.

The controller 14-50 controls the overall operations of the main base station. For example, the controller 14-50 transmits and receives a signal through the baseband processor 14-20 and the RF processor 14-10 or through the backhaul communication unit 14-30. The controller 14-50 records data in the memory 14-40 and reads the data. To this end, the controller 14-50 may include at least one processor.

1. A method performed by a terminal in a wireless communication system, the method comprising:
receiving a measurement configuration for logged minimization of drive test (MDT) from a first base station of a first network related to a first subscriber identity module (SIM) of the terminal;
entering a radio resource control (RRC) inactive state or an RRC idle state based on an RRC release message received from the first base station; and
in case that the logged MDT is affected by paging received from a second base station of a second network related to a second SIM of the terminal or by data received from the second base station or transmitted to the second base station, transmitting, to the first base station, a measurement result including an indicator indicating that the logged MDT has been affected.

2. The method of claim 1, wherein the indicator is included in log measurement information affected by the paging,
wherein the log measurement information includes measurement information for a serving cell, and
wherein the measurement information for the serving cell includes a measurement result of a valid serving cell which the terminal last collected.

3. The method of claim 1, wherein at least one of a cell or a frequency by which the logged MDT is affected is included in the log measurement information affected by the paging.

4. The method of claim 1, further comprising stopping a logged MDT operation.

5. A method performed by a first base station of a first network related to a first subscriber identity module (SIM) of a terminal in a wireless communication system, the method comprising:
transmitting a measurement configuration for logged minimization of drive text (MDT) to the terminal;
transmitting a radio resource control (RRC) release message for the terminal to enter an RRC inactive state or an RRC idle state; and
in case that the logged MDT is affected by paging transmitted from a second base station of a second network related to a second SIM of the terminal or by data transmitted from the second base station receiving, from the terminal, a measurement result including an indicator indicating that the logged MDT has been affected.

6. The method of claim 5, wherein the indicator is included in log measurement information affected by the paging,
wherein the log measurement information includes measurement information for a serving cell, and
wherein the measurement information for the serving cell includes a measurement result of a valid serving cell which the terminal last collected.

7. The method of claim 5, wherein at least one of a cell or a frequency by which the logged MDT is affected is included in the log measurement information affected by the paging.

8. The method of claim 5, wherein a logged MDT operation is stopped.

9. A terminal in a wireless communication system, the terminal comprising:
a transceiver; and
a controller coupled with the transceiver and configured to:
receive a measurement configuration for logged minimization of drive test (MDT) from a first base station of a first network related to a first subscriber identity module (SIM) of the terminal;
enter a radio resource control (RRC) inactive state or an RRC idle state based on an RRC release message received from the first base station; and
in case that the logged MDT is affected by paging received from a second base station of a second network related to a second SIM of the terminal or by data received from the second base station or transmitted to the second base station, transmit, to the first base station, a measurement result including an indicator indicating that the logged MDT has been affected.

10. The terminal of claim 9, wherein the indicator is included in log measurement information affected by the paging,
wherein the log measurement information includes measurement information for a serving cell, and
wherein the measurement information for the serving cell includes a measurement result of a valid serving cell which the terminal last collected.

11. The terminal of claim 9, wherein at least one of a cell or a frequency by which the logged MDT is affected is included in the log measurement information affected by the paging.

12. The terminal of claim 9, wherein the controller is configured to stop a logged MDT operation.

13. A base station of a first network related to a first subscriber identity module (SIM) of a terminal in a wireless communication system, the terminal comprising:
a transceiver; and
a controller coupled with the transceiver and configured to:
transmit a measurement configuration for logged minimization of drive text (MDT) to the terminal;
transmit a radio resource control (RRC) release message for the terminal to enter an RRC inactive state or an RRC idle state; and
in case that the logged MDT is affected by paging transmitted from a second base station of a second network related to a second SIM of the terminal or by data transmitted from the second base station, receive, from the terminal, a measurement result including an indicator indicating that the logged MDT has been affected.

14. The base station of claim 13, wherein the indicator is included in log measurement information affected by the paging,
wherein the log measurement information includes measurement information for a serving cell, and
wherein the measurement information for the serving cell includes a measurement result of a valid serving cell which the terminal last collected.

15. The base station of claim 13, wherein at least one of a cell or a frequency by which the logged MDT is affected is included in the log measurement information affected by the paging, and
wherein a logged MDT operation is stopped.
